(19) United States
(12) Patent Application Publication
(10) Pub. No.: US 2026/0052381 A1
(43) Pub. Date: Feb. 19, 2026

(54) METHODS FOR ESTABLISHMENT AND USE OF EPHEMERAL SECURITY BETWEEN AIOT ENTITIES

(71) Applicant: InterDigital Patent Holdings, Inc., Wilmington, DE (US)

(72) Inventors: Alec Brusilovsky, Downingtown, PA (US); Martino Freda, Laval (CA); Guanzhou Wang, Brossard (CA); Michael Starsinic, Newtown, PA (US); Mohamad Kenan Al-Hares, Canterbury (GB); Zhibi Wang, Woodridge, IL (US); Ulises Olvera-Hernandez, Saint-Lazare (CA); Anuj Sethi, Ottawa (CA)

(73) Assignee: InterDigital Patent Holdings, Inc., Wilmington, DE (US)

(21) Appl. No.: 18/807,177

(22) Filed: Aug. 16, 2024

(51) Int. Cl. H04W 12/043; H04W 68/02; H04W 74/0816; H04W 74/0833

(52) U.S. Cl. CPC H04W 12/043; H04W 68/02; H04W 74/0816; H04W 74/0833

(57) ABSTRACT

Systems, methods, and apparatuses for establishing an ephemeral security context between an ambient internet of things (AIOT) device and a reader device are provided herein. The reader device transmits a plurality of cryptographic puzzles and one or more puzzle parameters to the AIOT device. Each cryptographic puzzle is associated with a tuple comprising an ephemeral key and an ephemeral key index associated with the ephemeral key. The plurality of cryptographic puzzles may include reverse encryption based cryptographic puzzles and/or reverse cryptographic hash functions. The AIOT device selects and solves a cryptographic puzzle of the plurality of cryptographic puzzles and recovers the ephemeral key corresponding to the selected cryptographic puzzle. The AIOT device transmits a first message including a random device identifier and an ephemeral key index corresponding to the recovered ephemeral key. The AIOT device and the reader device establish the ephemeral security context based on the ephemeral key.

### BACKGROUND

Some ambient powered devices, for instance, ambient internet of things (AIOT) devices, may be connected to internet by way of one or more wireless communication networks. The AIOT devices may have a limited processing capacity with little or no power storage capacity. Conventionally, a security context for wireless communication with a wireless device is established using one or more pre-shared keys and/or through one or more key exchange protocols, which are complex and resource intensive. Therefore, such key exchange protocols cannot be used with the AIOT devices. As a result, for the AIOT devices, security for wireless communication may be provided by an AIOT reader device and/or a network connected to the AIOT devices. Therefore, there is a need for a technique to establish secure communication with the AIOT devices in a short period of time without requiring complex and/or resource-intensive processes.

### SUMMARY

In an embodiment, a method performed by a wireless transmit/receive unit (WTRU) is provided. The method includes receiving a paging message from a reader device. The method further includes receiving a puzzle message from the reader device. The puzzle message is indicative of a plurality of cryptographic puzzles and one or more puzzle parameters. Each cryptographic puzzle of the plurality of cryptographic puzzles is associated with an ephemeral key and a corresponding ephemeral key index. The method further includes selecting a cryptographic puzzle from the plurality of cryptographic puzzles. The method further includes solving the selected cryptographic puzzle using at least one puzzle parameter of the one or more puzzle parameters associated with the selected cryptographic puzzle. The method further includes recovering the ephemeral key associated with the selected cryptographic puzzle and its corresponding ephemeral key index. The method further includes transmitting a first message to the reader device. The first message comprises an e.g., random device identifier and the ephemeral key index recovered from the solved cryptographic puzzle.

In an embodiment, a wireless transmit/receive unit (WTRU) comprising a memory, a transceiver, and a processor is provided. The transceiver is configured to receive a puzzle message from a reader device. The puzzle message is indicative of a plurality of cryptographic puzzles and one or more puzzle parameters per puzzle. Each cryptographic puzzle of the plurality of cryptographic puzzles is associated with an ephemeral key and a corresponding ephemeral key index. The processor is configured to randomly select a cryptographic puzzle from the plurality of cryptographic puzzles. The processor is further configured to solve the selected cryptographic puzzle using at least one puzzle parameter of the one or more puzzle parameters associated with the selected cryptographic puzzle to recover the ephemeral key associated with the selected cryptographic puzzle and its corresponding ephemeral key index. The transceiver is further configured to transmit a first message to the reader device. The first message comprises a random device identifier and the ephemeral key index recovered from the solved puzzle.

In an embodiment, the WTRU establishes an ephemeral security context between the WTRU and the reader device using the ephemeral key.

In an embodiment, the WTRU receives a synchronization message from the reader device. The synchronization message is indicative of a plurality of transmission occasions. The WTRU selects a transmission occasion from the plurality of transmission occasions using a slotted additive links on-line Hawaii area (ALOHA) protocol. The WTRU transmits the first message using the selected transmission occasion.

In an embodiment, the plurality of cryptographic puzzles include at least one of: a cyphertext or a cryptographic hash function. The one or more puzzle parameters include at least one of: a partial encryption key or a partial input hash function argument.

In an embodiment, the randomly selected cryptographic puzzle is solved by brute-forcing at least one of: the cyphertext or the cryptographic hash function using at least one of: the partial encryption key or the partial input hash function argument respectively.

In an embodiment, the WTRU randomly selects the cryptographic puzzle from the plurality of cryptographic puzzles if a corresponding puzzle strength meets one or more security requirements.

In an embodiment, transmitting the first message to the reader device is for initiating a random access procedure.

In an embodiment, the WTRU receives a second message from the reader device in response to the first message. The WTRU determines whether the second message comprises the random device identifier.

In an embodiment, on a condition that the random device identifier in the second message is encrypted using the ephemeral key, the WTRU decrypts the second message using the ephemeral key.

In an embodiment, the WTRU is an ambient internet of things (AIOT) device.

In an embodiment, the WTRU transmits the first message on a condition that the paging message includes an identifier associated with the WTRU.

In an embodiment, a method for communicating with an AIOT device is provided. The method comprises generating a plurality of tuples. Each tuple of the plurality of tuples comprises an ephemeral key and a corresponding ephemeral key index. The method further comprises generating a plurality of cryptographic puzzles based on the plurality of tuples. The method further comprises transmitting a puzzle message to the AIOT device. The puzzle message is indicative of the plurality of cryptographic puzzles and one or more puzzle parameters associated with each puzzle. The method further comprises receiving a first message from the AIOT device. The first message comprises a random device identifier and an ephemeral key index corresponding to a cryptographic puzzle of the plurality of cryptographic puzzles. The method further includes determining the ephemeral key associated with the received ephemeral key index. The method further includes establishing an ephemeral security context with the AIOT device using the determined ephemeral key.

In an embodiment, the plurality of cryptographic puzzles include at least one of: a cyphertext or a cryptographic hash function. The one or more puzzle parameters include at least one of: a partial encryption key or a partial input hash function argument.

In an embodiment, the method includes modifying a puzzle strength associated with a cryptographic puzzle of the plurality of cryptographic puzzles based on one or more of: a memory productivity of the AIOT device, a processing productivity of the AIOT device, an amount of time required to solve the cryptographic puzzle, or an amount of effort required to solve the cryptographic puzzle.

In an embodiment, modifying the puzzle strength associated with the cryptographic puzzle comprises changing a proportion between at least one of: the partial encryption key and a corresponding encryption key, or the partial input hash function argument and a corresponding input hash function argument.

In an embodiment, the method further includes transmitting a second message to the AIOT device. The second message comprises the received random device identifier and an acknowledgement. The method further includes encrypting received random device identifier in the second message using the determined ephemeral key.

In an embodiment, the method may be performed by at least one of: an AIOT reader device, a wireless transmit/receive unit, a base station, or a network function.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates example sleep and active periods of an ambient internet of things (AIOT) device in an embodiment;

FIG. 3 illustrates an example AIOT random access framework in an embodiment;

FIG. 4 illustrates an example ephemeral key agreement using one or more cryptographic puzzles in an embodiment;

FIG. 5 illustrates an example process of a configuration and/or an assembly of a cryptographic puzzle based on reversing encryption in an embodiment;

FIG. 6 shows an example process for a configuration and/or an assembly of a cryptographic puzzle based on reversing of a cryptographic hash function in an embodiment;

FIG. 7 illustrates an example process of solving an encryption reversing puzzle in an embodiment;

FIG. 8 illustrates an example process of solving a hash function reversing puzzle in an embodiment;

FIG. 9 illustrates an example process for a modified random access procedure for establishing an ephemeral security between an AIOT device and a reader device in an embodiment;

FIG. 10 illustrates an example process of a modified random access procedure for establishing an ephemeral security between an AIOT device and a reader device in an embodiment;

FIG. 11 illustrates a process for a modified random access procedure for remediation of a SPARROW attack in an embodiment;

FIG. 12 illustrates an example process for an AIOT device identity and security bootstrapping in an embodiment;

FIG. 13 illustrates an example process for an extensible authentication protocol (EAP) authentication procedure protected by a security tunnel based on a medium access control (MAC) security context in an embodiment;

FIG. 14 is a flowchart illustrating an example process performed by an AIOT device in an embodiment; and

FIG. 15 is a flowchart illustrating an example process performed by a reader device in an embodiment.

### DETAILED DESCRIPTION

As discussed herein, one or more abbreviations in the following (non-exhaustive) list, shown in Table 1, may be used herein.

TABLE 1

| | |
|---|---|
| AAA | Authentication, Authorization, and Accounting [server] |
| AIOT | Ambient Internet of Things (IoT) |
| AF | Application Function |
| ALOHA | Advocates of Linux Open-source Hawaii Association |
| EAP | Extensible Authentication Protocol |
| GSMA | GSM Association |
| FASG | Fraud And Security Group [of GSMA] |
| MAC | Media Access Control |
| OTA | Over The Air |
| RACH | Random Access Channel |
| RAN | Radio Access Network |
| SPARROW | Stealth Pirating Attack by RACH Rebroadcast Overwriting |

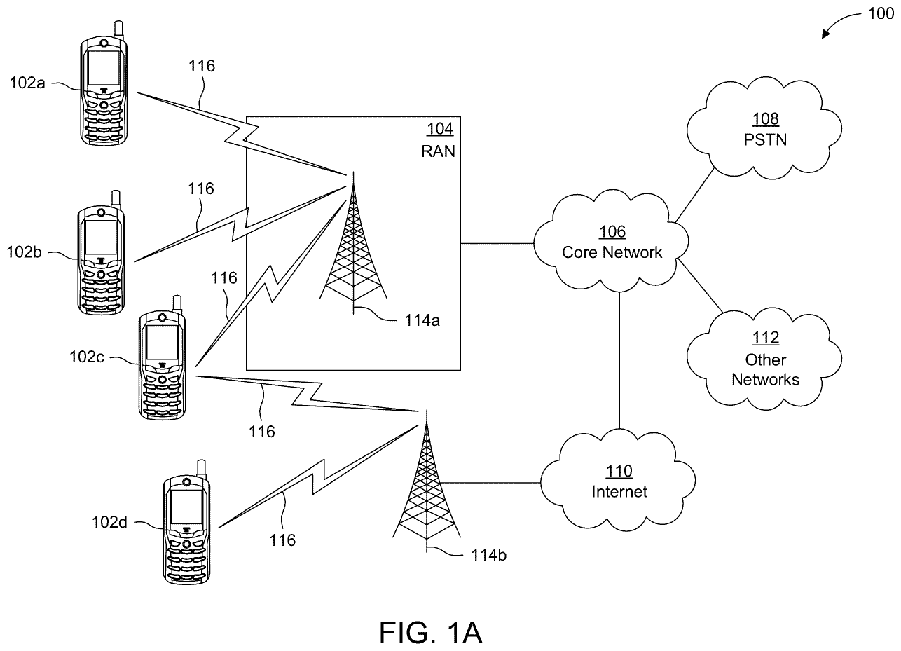

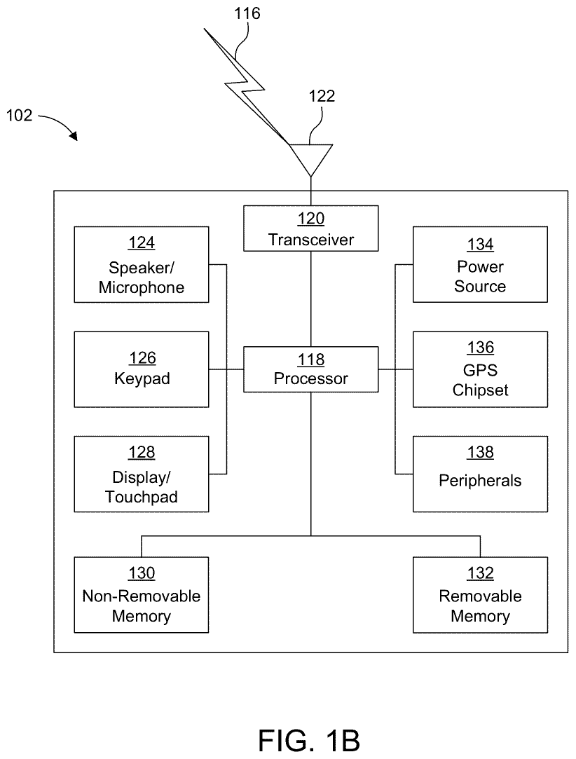

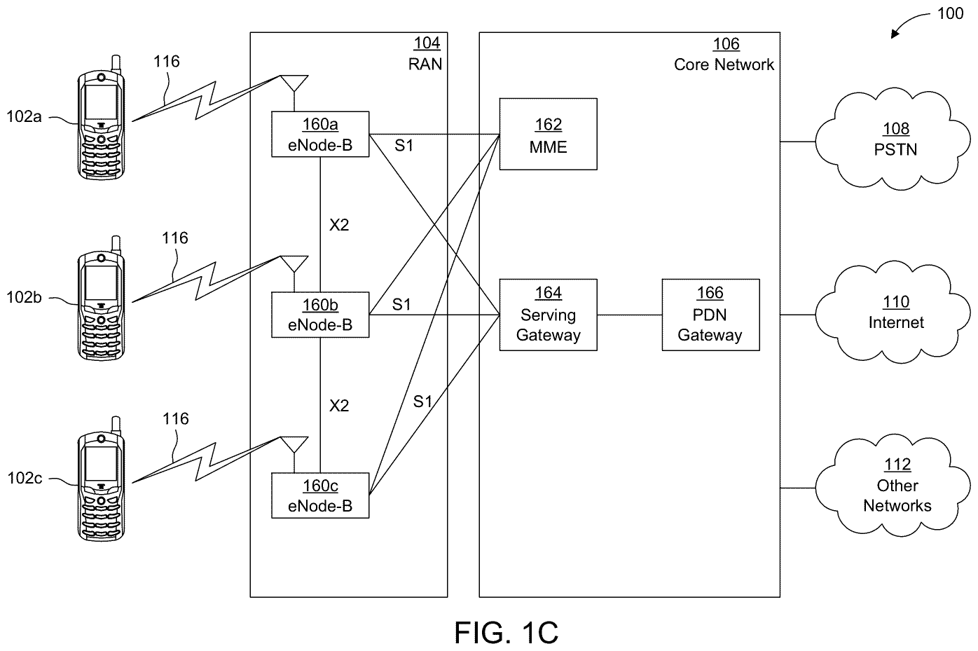

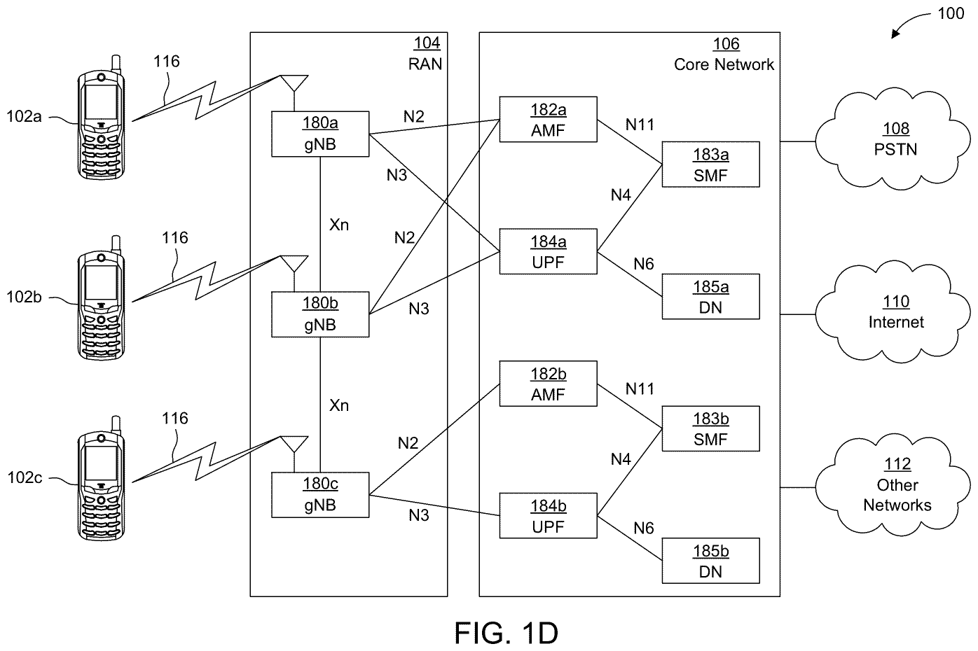

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In an embodiment, one or more methods and/or frameworks for establishment of an ephemeral security context by a medium access control (MAC) layer are provided by the present disclosure. In an embodiment, the present disclosure provides one or more security methods and/or frameworks for ambient internet of things (AIOT) devices. An ephemeral security method of the present disclosure uses one or more cryptographic puzzles to establish the ephemeral security between an AIOT reader device and/or a base station (e.g. a NodeB) and an AIOT device (and/or a WTRU and/or a wireless station (STA) and/or a user equipment (UE) etc.). The present disclosure also provides one or more methods and/or frameworks for bootstrapping a permanent security for the AIOT device by using the ephemeral security context by the MAC layer. The present methods and/or frameworks provide establishment of an AIOT security earlier and on a different protocol stack layer than a packet data convergence protocol (PDCP) layer to either augment and/or avoid a PDCP security. The present methods and/or frameworks provide authentication and authorization, confidentiality, integrity, replay protection, and/or privacy protection etc.

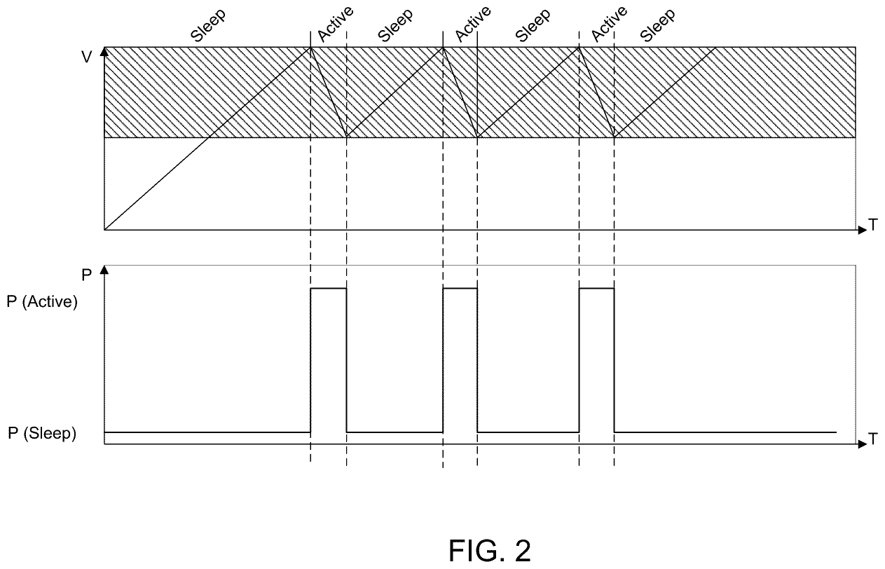

In an example, a study of AIOT in RAN in TR 38.848 identifies at least three device types, viz, device type A, device type B, and device type C. The device type A includes a type of devices with no energy storage, and in which transmission is performed by using backscattering alone. The device type B includes the devices that use backscattering (e.g. similar to the device type A) but can perform power boosting by using energy stored in the devices (e.g. power derived from any type of energy harvesting methods etc.). The device type C includes the devices that can perform autonomous transmission (i.e., without the need for backscattering) at one or more periods of time when the devices have stored sufficient energy by energy harvesting. In case of device types B and C, the devices (e.g. one or more UEs etc.) may operate in one or more short active periods while performing energy harvesting during one or more sleep periods as shown in FIG. 2.

FIG. 2 illustrates example sleep and active periods of an AIOT device in an embodiment. As shown in FIG. 2 the AIOT device may harvest energy during a sleep period, i.e., when the AIOT device operates in a sleep mode, and the AIOT device may utilize a part of the harvested energy in an active period, i.e., when the AIOT device transmits, receives, processes, generates and/or senses data in an operational mode.

In an example, multiple observations related to availability as a facet of security (WT 5.1) in SA2 AIOT SID are described below. In an observation, the TS 22.369 “Service requirements for ambient power-enabled IoT includes the following security requirements: In 5.2.6 security and privacy, a 5G system may enable security protection suitable for the AIOT devices, without compromising overall 5G security protection. The 5G system may be able to provide a mechanism to protect a privacy of information (e.g., location and/or identity etc.) exchanged during communication between the AIOT device and the 5G network and/or an AIOT-capable UE (e.g. the WTRU). Based on subscription and/or one or more operator policies, the 5G system may authorize the AIOT-capable UE (e.g. the WTRU) to communicate with a specific AIOT device and/or with a group of AIOT devices.

In an observation, TS 22.369 also provides one or more performance service requirements in clauses 6.2, 6.3, 6.4, and 6.5 that include communication service availability. For most services, the communication service availability is 99% and for some, the communication service availability reaches 99.9%.

In an observation, a security triad, viz., confidentiality, integrity, and availability, is a guiding model in information security. A comprehensive information security strategy includes one or more policies and/or one or more security controls that minimize a threat to these three crucial components. In an example, the confidentiality refers to protecting information from an unauthorized access. In an example, the integrity signifies that the data are trustworthy, complete, and have not been accidentally altered and/or modified by an unauthorized user. In an example, the availability signifies that the data are accessible when you need them. In an example, in a context of the AIOT devices, the availability is a part of the AIOT security and an availability requirement in KI corresponding to WT 5.1.

In an observation, per RAN2, one or more inventory and/or command services for the AIOT devices and/or procedures are provided. In an example, an inventory is a procedure used by a reader device to discover and/or acquire an identifier of a single AIOT device and/or a group of AIOT devices. In an example, a command is a procedure used by the reader device to transmit an operation request (e.g. a read request and/or a write request) to the single AIOT device and/or the group of AIOT devices.

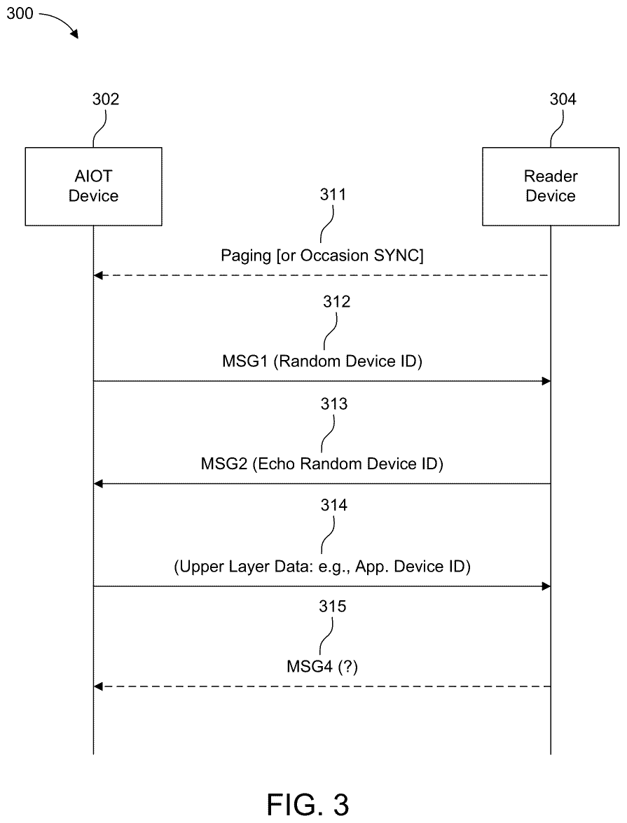

FIG. 3 illustrates an example agreed AIOT random access framework 300 in an embodiment. FIG. 3 illustrates an example method of the AIOT random access performed by an AIOT device 302 and a reader device 304. At 311, the reader device 304 generates and transmits a paging message and/or one or more occasion synchronization messages to the AIOT device. The paging message and/or the one or more occasion synchronization messages respectively provide one or more device identifiers (IDs) of the one or more AIOT devices (e.g. including the AIOT device 302) to respond and configure and/or delimit one or more random access occasions for transmissions by the one or more AIOT devices.

At 312, the AIOT device 302 selects an occasion (using at least slotted ALOHA as a baseline), and transmits, to the reader device 304, a random device ID in a first message (i.e. a MSG1).

At 313, the reader device 304, upon successful reception of the first message (i.e. the MSG1), transmits a second message (i.e. a MSG2) by including the received random device ID in the second message (i.e. the MSG2).

At 314, if the AIOT device 302 receives the echoed random device ID in the second message (i.e. the MSG2), the AIOT device 302 transmits, to the reader device 304, a third message (i.e. a MSG3) which includes upper layer data (e.g., an application layer device ID etc.).

At 315, a fourth message (i.e. a MSG4) may be transmitted by the reader device 304 (e.g., for a subsequent command transmission etc.), but an understanding is that a contention is already resolved at the second message (i.e. the MSG2) transmission.

The term “reader” and/or “reader device” in this disclosure may refer to a base station and/or an intermediate node. The term “intermediate node” in this disclosure may refer to the WTRU (e.g. the UE) that is able to communicate with the one or more AIOT devices and relay information from the one or more AIOT devices to the network. The term ‘bootstrapping’ may be related to building an ephemeral security relation with a previously unknown device first and/or allowing an installation of one or more security elements (e.g., one or more keys and/or credentials etc.) in the AIOT device, and the network and/or an application function (AF) afterward.

In an example, one or more ephemeral credentials may include one or more dynamically generated credentials that are created and/or generated when the one or more credentials are needed and then discarded afterward. Like one or more persistent credentials, the one or more ephemeral credentials provide a token that may be used to gain access to a particular resource. In an example, a difference is, that with the one or more ephemeral credentials, the token eventually expires, and the AIOT device may need to go through an authentication process again. The one or more ephemeral credentials may be gone upon expiry, and there may not be any way to refresh the one or more ephemeral credentials like one or more short-lived credentials and/or one or more long-lived credentials. In an example, there exists a difference between the one or more ephemeral credentials and the one or more short-lived credentials and/or the one or more long-lived credentials. In an example, the one or more short-lived credentials, like the one or more ephemeral credentials, may be temporary. In an example, the difference may be that the one or more short-lived credentials may be refreshed. The one or more long-lived and/or persistent credentials may not be temporary. Examples of the one or more long-lived credentials and/or the one or more persistent credentials may include but are not limited to one or more usernames, passwords, and/or API keys etc. that typically do not expire. The one or more ephemeral credentials may eliminate multiple problems and/or drawbacks (e.g., privacy aspects etc.) related to one or more persistent access credentials and/or a security context.

In an existing TR 33.713 key issue #3, privacy by protecting one or more AIOT device identifiers, specifies multiple requirements, including, for instance, a requirement of including one or more mechanisms for mitigating privacy threats by identifying, linking, and/or tracking the one or more identifiers of the one or more AIOT devices. Such protection may require the one or more AIOT devices and the reader device to establish a security association.

A current 3GPP security relates to the PDCP layer which may or may not be employed in the one or more AIOT devices and/or procedures based on one or more RAN2 assumptions. In a baseline procedure for use cases related to “inventory” and “command”, the RAN2 supports two use cases, viz, “inventory” and “command”.

In an example, in the baseline procedure, based on a service request, the reader device transmits an initial trigger message indicating the one or more AIOT devices that need to respond. One or more triggered AIOT devices may perform a random access-like procedure, if needed. An AIOT device may perform a data communication with the reader device as needed.

In an observation, a current “above MAC layer security” (e.g., the PDCP) may makes it necessary to exchange one or more identities and/or credentials in cleartext, unprotected.

In an observation, usually, there are at least two security mechanisms to establish a security context, either through one or more shared credentials (e.g., a secret K that is shared between a cellular CN and the WTRU), and/or through a public key infrastructure (PKI) that allow the WTRU (and/or the UE) and the CN to come up with the security context, but the baseline procedure includes neither and an anticipated simplicity of the one or more AIOT devices may make including either of those security mechanisms unfeasible.

Therefore, there is a need to establish the security between the AIOT reader device and/or the NodeB and the AIOT device before, below (e.g., at the MAC layer), and/or instead of the PDCP layer in a way that is applicable to the AIOT device (e.g., considering one or more power and/or complexity requirements associated with the AIOT device).

The above security problem and/or drawback is addressed by an ephemeral security association used for remediation of a SPARROW attack in the present disclosure.

There is also a need to bootstrap more permanent security associations from the MAC layer ephemeral security association.

In an embodiment, the present disclosure provides a modified random access procedure for establishing the ephemeral security between the AIOT device and the reader device.

In an embodiment, the present disclosure provides a modified agreed AIOT random access procedure for establishing the ephemeral security between the AIOT device and the reader device.

In an embodiment, the ephemeral security context obtained in the course of the random access procedure (RACH) is used to remediate against the SPARROW attack.

In an embodiment, the present disclosure provides the AIOT device identity and/or security bootstrapping.

In an embodiment, the present disclosure provides an authentication procedure protected by a security tunnel based on a MAC security context.

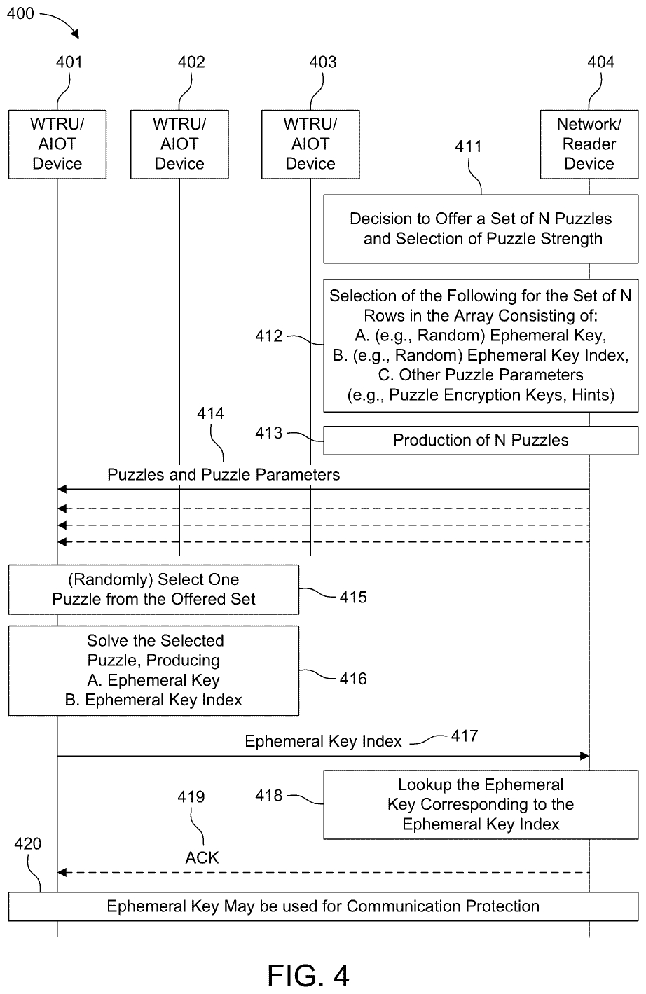

FIG. 4 illustrates an example ephemeral key agreement 400 using one or more cryptographic puzzles in an embodiment. A method of establishing the ephemeral key agreement 400 may be performed by first through third WTRUs and/or AIOT devices, viz, a first AIOT device 401, a second AIOT device 402, and a third AIOT device 403 and a reader device 404 (and/or the WTRU and/or the AIOT-enabled UE and/or the network etc.). The first AIOT device 401 and the reader device 404 may not have any pre-established security context. At 411, the reader device 404 may decide to offer a plurality of cryptographic puzzles, such as a set of N cryptographic puzzles of a certain strength.

At 412, the reader device 404 may select and/or generate one or more parameters for a set of N rows in an array including but not limited to an ephemeral key (e.g., random), an ephemeral key index (e.g., random), one or more other puzzle parameters (e.g., one or more puzzle encryption keys and/or hints etc.).

At 413, the reader device 404 may produce and/or generate the set of N cryptographic puzzles using the one or more parameters, the ephemeral key index, and/or the one or more other puzzle parameters etc.

At 414, the reader device 404 may transmit (e.g., broadcast) the set of N cryptographic puzzles including the one or more optional hints and/or the one or more parameters to the first through third AIOT devices 401-403 that may be associated with every puzzle. The one or more parameters may include difficulty and/or strength level and corresponding power consumption rating for solving one or more cryptographic puzzles.

At 415, a particular AIOT device e.g. the first AIOT device 401 may select (e.g. randomly select) a particular cryptographic puzzle from the set of N cryptographic puzzles.

At 416, the first AIOT device 401 may solve the selected cryptographic puzzle (e.g., using the one or more optional hints and/or using the one or more other received parameters) to produce and/or recover the ephemeral key and the corresponding ephemeral key index.

At 417, the first AIOT device 401 may transmit the recovered ephemeral key index to the reader device 404.

At 418, the reader device 404 may perform a lookup in a table and/or an array and find the ephemeral key corresponding to the received ephemeral key index.

At 419, the reader device 404 may optionally transmit an acknowledgment message to the first AIOT device 401 (e.g., broadcast, multicast, and/or unicast etc.).

At 420, the reader device 404 and the first AIOT device 401 may agree on the ephemeral security key to be used in communication protection.

In an embodiment, multiple puzzles, different types of puzzles and/or cryptographic puzzles, multiple elements and/or parameters of the puzzles, different methods of puzzle compositions may be used in the present disclosure. In an example, a puzzle may be any cryptographic primitive (e.g. encryption and/or hash function etc.) that would require a brute-force attack to reverse.

In an example, a puzzle may be a reversing of an encryption. The puzzle may include finding a plaintext and/or a partial plaintext with no encryption key knowledge, partial key knowledge, and/or reduced key size. In an example, increasing and/or decreasing the key size and/or other parameters of the puzzle may modulate a strength of the puzzle, an amount of work, and/or an amount of effort that an entity (e.g., the AIOT device) has to spend to solve the puzzle. A processor productivity may have an outsized effect on a time needed to reverse the encryption. The one or more puzzle parameters may include the key length (e.g., 128 for AES-128), a known key length (e.g., 120), leaving 8 bit for the brute-force attack, and the cyphertext. The cleartext corresponding to the cyphertext may be hint allowing the brute-force process to stop.

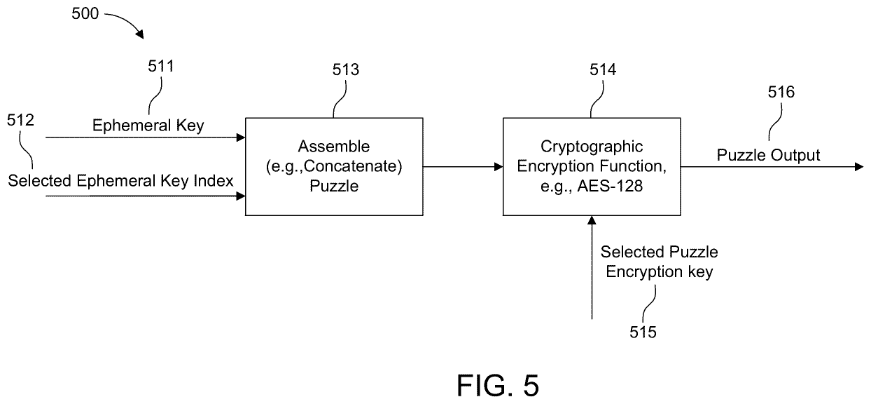

FIG. 5 illustrates an example process 500 of a configuration and/or an assembly of a cryptographic puzzle based on the reversing encryption in an embodiment. The process 500 may be triggered by the reader device.

At 511, the reader device may select (e.g., randomly select) the ephemeral key to be encrypted by the puzzle output.

At 512, the ephemeral key index may be e.g., randomly produced. The ephemeral key and the corresponding ephemeral key index tuple may be memorized in the reader device.

At 513, the ephemeral key and the selected ephemeral key index may be assembled (e.g., concatenation of the ephemeral key with the ephemeral key index). An ability to subsequently parse the ephemeral key and the ephemeral key index apart may be achieved by one or more methods such as but not limited to using one or more predefined lengths and/or using one or more selected separation characters etc., for example.

At 514, the reader device may perform the cryptographic encryption function that produces the puzzle.

At 515, a key of a selected strength may be used for the assembled puzzle content encryption.

At 516, the reader device generates the puzzle output.

In an embodiment, the puzzle may include reversing of one-way cryptographic hash function (e.g., SHA-256). In that, the puzzle may include finding an input argument with a partial input hash function argument knowledge. In an example, increasing and/or decreasing a proportion between known and unknown portions of the hash function input may change the strength of the puzzle and/or the amount of work and/or effort that the entity (e.g., the WTRU, the AIOT-enabled UE, and/or the AIOT device etc.) may have to spend to solve the puzzle. Productivity of the RAM of the entity (e.g., the WTRU, the AIOT-enabled UE, and/or the AIOT device etc.) may have an outsized effect on a time needed to reverse the hash function.

The partially known argument to the cryptographic hash function may be the input parameter. In an example, when using SHA-256 cryptographic hash, the input string to the hash has a total length of N and a known input length of N-m. The hash output is provided as one of the input parameters (stated length of 256 for SHA-256). It is the m-bits of the input to the hash function that are not known and comprise the puzzle. The effort is needed to use the brute-force attack and discover the unknown m-bits of input, so that output=HASH-256 (known input∥unknown input).

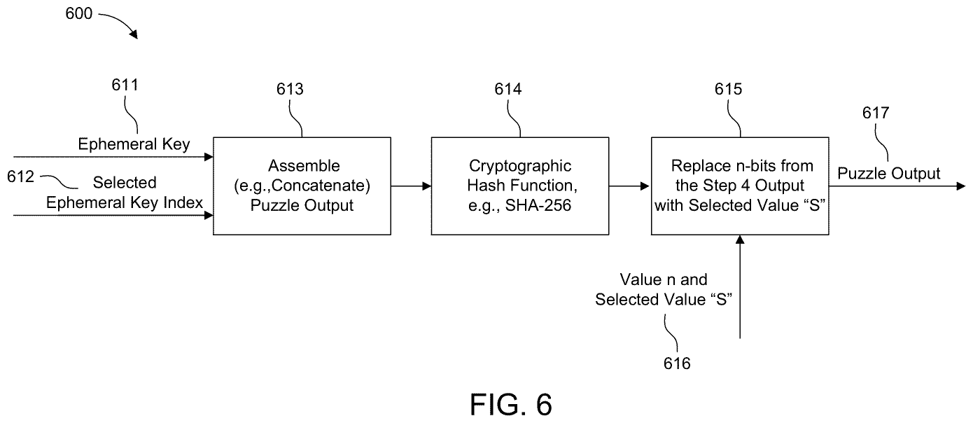

FIG. 6 shows an example process 600 for a configuration and/or an assembly of a cryptographic puzzle based on reversing of a cryptographic hash function in an embodiment. At 611, the reader device may select (e.g. randomly select) the ephemeral key to be encrypted by the puzzle output.

At 612, the ephemeral key index may be produced (e.g. randomly generated and/or selected etc.). The ephemeral key and the corresponding ephemeral key index tuple may be memorized in the reader device, i.e. stored in a memory in the reader device.

At 613, the input (e.g., concatenation of the ephemeral key with the ephemeral key index) may be assembled. The ability to subsequently parse these components apart may be achieved by one or more methods such as but not limited to using one or more predefined lengths and/or one or more selected separation characters etc.

At 614, the cryptographic hash function (e.g., SHA-256) that produces the puzzle is executed.

At 615, one or more bits, e.g. n bits (e.g. either leading, trailing, and/or random bits etc.) of the output with the e.g. selected character “S” may be replaced.

At 616, an n-bit value and replacement character, e.g. “S” are selected.

At 617, the puzzle output is assembled.

In an embodiment, different methods and/or associated processes, including anticipated methods, steps, inputs, and/or outputs, may be used for puzzle-solving.

In an example, the brute-force attack may be used to solve the one or more puzzles. Solving the encryption reversing puzzle may use a brute-force method and may include finding plaintext and/or partial plaintext with either no encryption key knowledge, partial key knowledge, and/or reduced key size. Productivity of the processor of the WTRU and/or the UE and/or the AIOT device may have an outsized effect on the time and/or effort needed to reverse the encryption.

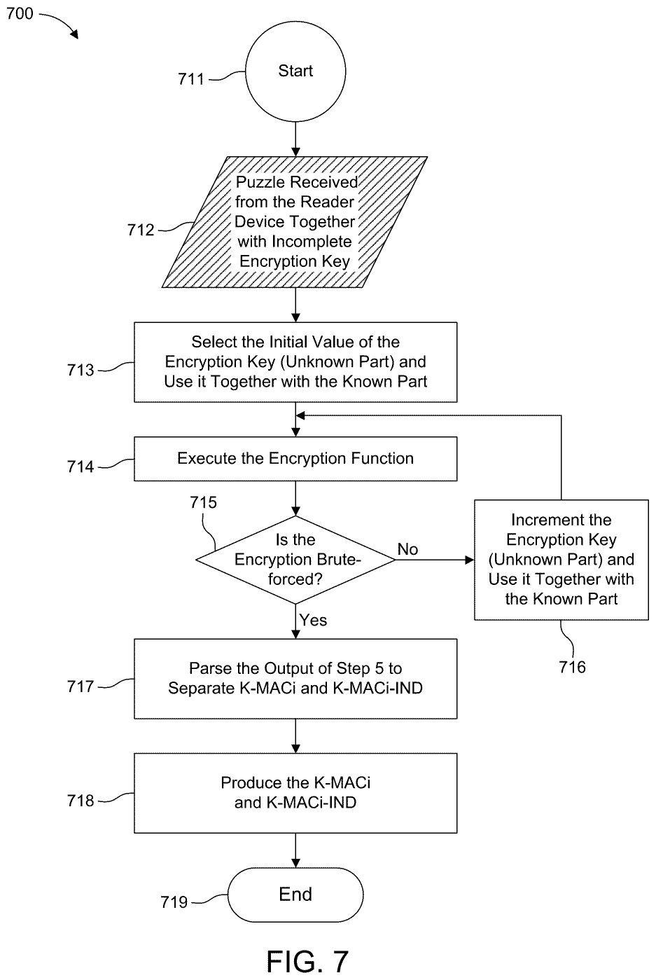

FIG. 7 illustrates an example process 700 of solving the encryption reversing puzzle in an embodiment. The process 700 may be performed by the AIOT device, the WTRU, and/or the UE etc. The process 700 of solving the encryption reversing puzzle may be built around going through all existing permutations of a whole encryption key while knowing the partial encryption key.

At 711, the AIOT device starts the process 700 of solving the encryption reversing puzzle.

At 712, the AIOT device receives the puzzle and the one or more corresponding parameters from the reader device. In an example, the AIOT device receives the puzzle and the incomplete encryption key.

At 713, the AIOT device selects an initial value of the encryption key (e.g., selects the starting value of the unknown part of the encryption key and uses the starting value together with the known part of the key).

At 714, the AIOT device executes the encryption function.

At 715, the AIOT device checks if the encryption is brute-forced (e.g., if the brute-forced cleartext includes the optional known clear text corresponding to the input). If no, at 716, the AIOT device may increment the unknown part of the key, use that part together with the known part and try to brute-force the encryption again in 714. If yes, at 717, the AIOT device may parse the cleartext to separate a key value (e.g. K-MACi) and a key index value (e.g. K-MACi-IND).

At 718, separate K-MACi and K-MACi-IND values from the encrypted text (i.e., brute-forced text) may be ready for the AIOT device to use.

At 719, the AIOT device finishes solving the puzzle.

In an embodiment, the present disclosure provides solving the one-way cryptographic hash function reversing puzzle. Solving the one-way cryptographic hash function (e.g., SHA-256) reversing puzzle may be based on the brute-force method and may include finding the complete hash function input text with only partial input hash function argument knowledge. In an example, increasing and/or decreasing the proportion between the known the and unknown portions of the hash function input may change the strength of the puzzle and/or the amount of work and/or effort that the entity (e.g., the WTRU, the AIOT device and/or the UE etc.) has to spend to solve the puzzle. In an example, changing lengths, e.g. a number of bits of the known and/or unknown portions of the hash function input may change the strength of the puzzle and/or the amount of work and/or effort required to solve the puzzle. The productivity of the RAM of the WTRU and/or the AIOT device and/or the UE may have an outsized effect on the time needed to reverse the hash function.

In an example, the partially known argument to the cryptographic hash function may be the input parameter. In an example, when using the SHA-256 cryptographic hash, the input string to the hash has a total length of N and a known input length of N-m. The hash output is provided as one of the input parameters (stated length of 256 for SHA-256). It is the m-bits of the input to the hash function that are not known and comprise the puzzle.

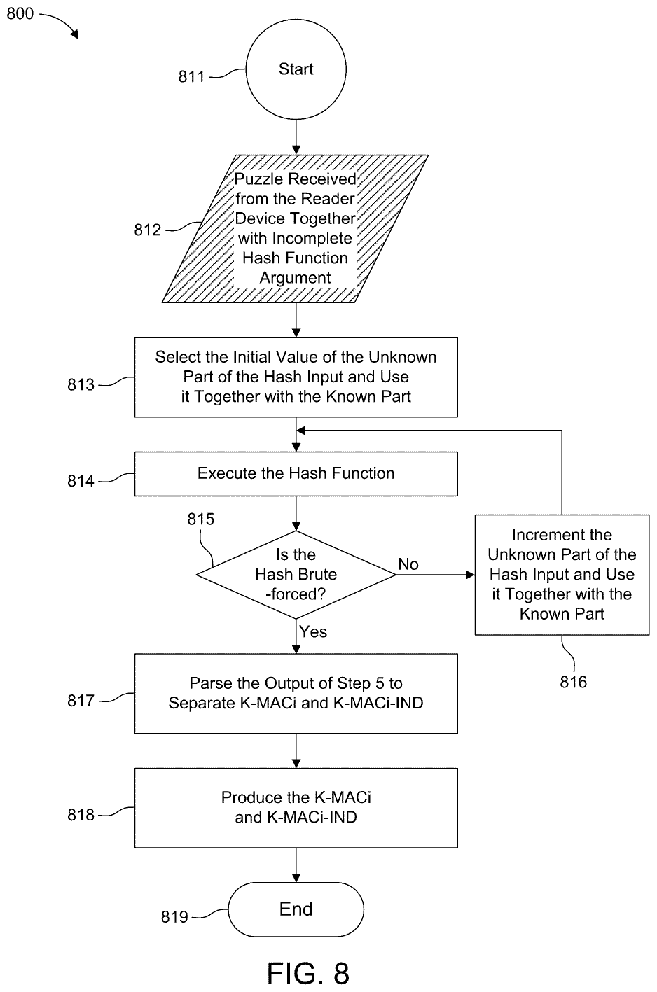

FIG. 8 illustrates an example process 800 of solving a hash function reversing puzzle in an embodiment. The process 800 may be performed by the WTRU and/or the UE and/or the AIOT device. At 811, the AIOT device starts the process 800 to solve the hash function reversing puzzle.

At 812, the AIOT device receives the puzzle and the one or more corresponding parameters from the reader device.

At 813, the AIOT device may select the initial value of the unknown part of the hash input (e.g., the starting value of the unknown part of the hash input) and use the initial value together with the known part of the hash input.

At 814, the AIOT device may execute the hash function.

At 815, the AIOT device may checks if the hash is brute-forced (e.g., if the hash output corresponds to the whole hash input). If no, at 816, the AIOT device may increment the unknown part of the hash input, use that part together with the known part and try to brute-force the hash again in 814. If yes, at 817, the AIOT device may parse the cleartext from 816 to separate the K-MACi and the K-MACi-IND values.

At 818, the AIOT may separate the K-MACi and the K-MACi-IND values from the encrypted text (i.e., brute-forced) and the -MACi and the K-MACi-IND values may be ready for the AIOT device to use.

At 819, the AIOT device finishes solving the puzzle.

In an embodiment, the present disclosure provides the modified NR random access procedure (NR RACH procedure) for establishing the ephemeral security e.g., between the AIOT device and the reader device.

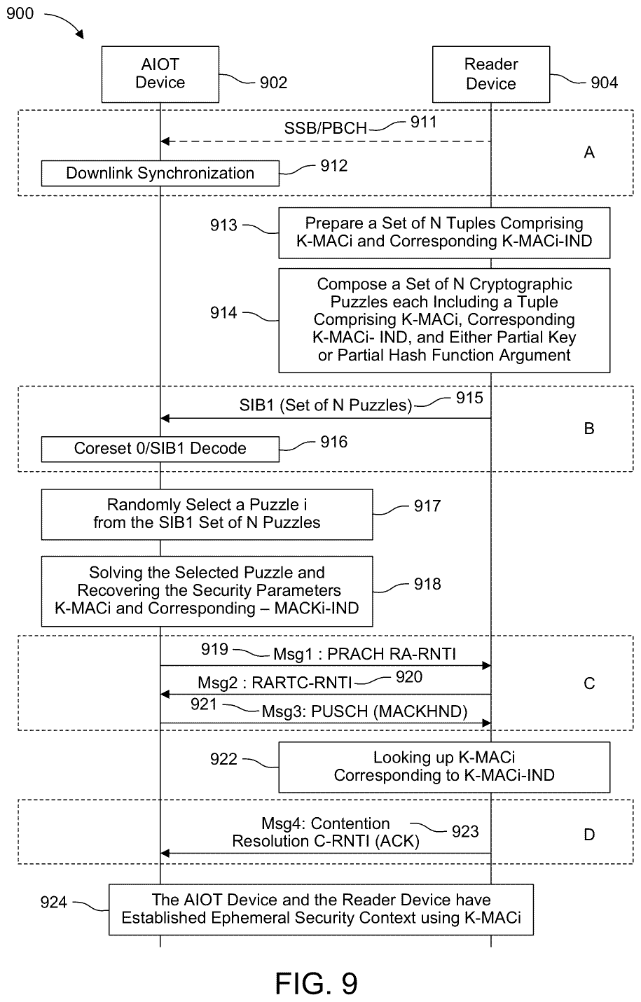

FIG. 9 illustrates an example process 900 for the modified NR random access procedure for establishing the ephemeral security between the AIOT device and the reader device in an embodiment. The example process 900 may be based on the modified random access procedure as per clause 5.1 of 3GPP TS 38.321. Prior to performing the example process 900, the AIOT device may have no security context established with the reader device. The process 900 may demonstrate how an AIOT device 902 and a reader device 904 may establish the security context as the part of the RACH procedure.

At 911, the reader device 904 may transmit the SSB/PBCH to the AIOT device 902.

At 912, the AIOT device 902 may perform a downlink synchronization procedure.

At 913, the reader device 904 may determine to prepare a set of cryptographic puzzles. The reader device 904 may determine to prepare the set of cryptographic puzzles based on a determination that the one or more AIOT devices are likely to soon perform the RACH procedure. The reader device 904 may make the determination that the one or more AIOT devices are likely to soon perform the RACH procedure based on receiving a notification from a NF and/or an AF that indicates that the one or more AIOT devices are likely to soon perform the RACH procedure. In an example, the NF and/or the AF may know a time window when the one or more AIOT devices are likely to attempt to transmit data to the network and the time window information may be provided to the reader device 904. The reader device 904 may make the determination that the one or more AIOT devices are likely to soon perform the RACH procedure based on the reader device 904 having sent a paging message that is addressed to the one or more AIOT devices. In an example, the reader device 904 may have received a request to page the one or more AIOT devices and the reader device 904 may decide to begin broadcasting the set of N puzzles after transmitting and/or broadcasting the paging message. In an example, the set of N puzzles may be transmitted using the paging message and/or a puzzle message.

Once the reader device 904 determines the need to have the set of cryptographic puzzles, the reader device 904 may prepare a set of N tuples. In an example, each tuple in the set of N tuples may comprise a K-MACi (i.e. the key) and corresponding K-MACi-IND (i.e. the key index corresponding to the key).

The reader device 904 may determine the set of cryptographic puzzles with complexity based on an available power in the AIOT device 902. In an example, the complexity of the cryptographic puzzles in the set of cryptographic puzzles might be associated with the ability of the AIOT device 902 to solve the cryptographic puzzles in terms of availability of power.

The reader device 904 may determine the set of cryptographic puzzles based on a security level associated with a task allocated to the AIOT device 902. In an example, a task related to one or more sensitive applications such as but not limited to medical applications may require the AIOT device 902 to be allocated a more complicated puzzle set.

At 914, the reader device 904 may generate the set of N cryptographic puzzles. In an example, each cryptographic puzzle may hide at least one tuple including the corresponding ephemeral key (i.e. the K-MACi), the corresponding ephemeral key index (i.e. the K-MACi-IND), and/or either a partial key and/or a partial hash function argument etc.

At 915, the reader device 904 may broadcast a message. The message may include the set of N cryptographic puzzles. The message may be broadcast in a SIB 1.

At 916, the AIOT device 902 may read the broadcast message. If the broadcast message was broadcasted in the SIB1, the reader device 904 may perform a decode procedure on CORESET 0 in order to read the SIB1, for example.

The AIOT device 902 may have determined to read the broadcast message because the AIOT device 902 may have determined that the AIOT device 902 needs to perform the RACH procedure. The AIOT device 902 may have determined that the AIOT device 902 needs to perform the RACH procedure because the AIOT device 902 received the paging message that indicated that the AIOT device 902 was being paged. The AIOT device 902 may have determined that the AIOT device 902 needs to perform the RACH procedure because the AIOT device 902 determined that the AIOT device 902 needs to transmit the data to the network. In an example, the AIOT device 902 may determine that the AIOT device 902 needs to transmit the data to the network when information and/or data is sensed (e.g. an environmental condition is detected) and/or when a timer expires (e.g. a registration or “check-in” timer expires) etc.

In 917, in an example, the AIOT device 902 may randomly select one puzzle from the set of N cryptographic puzzles that were received in step 915, alternatively, in another example, the AIOT device 902 may select the puzzle based on the puzzle strength. In an example, randomly selecting may mean that the AIOT device 902 selects any one of the N cryptographic puzzles. In an example, when the puzzles are numbered 0 through N−1, the AIOT device 902 may be configured to always select a certain number puzzle. In an example, the number that is always selected by the AIOT device 902 may be configured in the AIOT device 902 and/or the AIOT device 902 may determine the number based on an identifier of the AIOT device 902. The message that is broadcasted by the reader device 904 and includes the N cryptographic puzzles may also include the numbers that are associated with each puzzle. In an example, the numbers may be associated with and/or indicative of the strengths of the puzzles. The strength of the puzzle may refer to a difficulty level of the puzzle. In an example, an additional parameter may refer to an average power consumption level needed to solve the cryptographic puzzle. The power consumption level may be marked as low, medium or high power consumption.

At 918, the AIOT device 902 may solve the selected puzzle and recover one or more security parameters. In an example, recovering the one or more security parameters may include the AIOT device 902 using the received puzzle information to determine the one or more security parameters. Examples of the one or more security parameters may include but are not limited to the key (K-MACi-IND).

At 919, the AIOT device 902 may select a random access preamble from a set of predefined preambles. The AIOT device 902 may also select a random sequence number for the preamble. After choosing the preamble and the sequence number, the AIOT device 902 may transmit the preamble on the PRACH.

At 920, upon receiving the first message (i.e. MSG1), the reader device 904 may transmit one or more response messages (i.e. MSG2). A response message (i.e. the MSG2) may include several critical pieces of information, such as but not limited to a time advance (TA) command for timing adjustment, a random access preamble identifier (RAPID) matching the preamble sent by the AIOT device 902, and an initial uplink grant for the AIOT device 902. The reader device 904 also assigns a temporary identifier, such as a random access radio network temporary identifier (RA-RNTI) to the AIOT device 902.

At 921, using the initial uplink grant provided in the response message (i.e. the MSG2), the AIOT device 902 may transmit a third message (i.e. MSG3). The AIOT device 902 may include a key parameter, i.e. the K-MACi-IND parameter in the third message (i.e. the MSG3). The K-MACi-IND is the parameter that was recovered in step 918. The third message (i.e. the MSG3) may be transmitted on a physical uplink shared channel (PUSCH).

At 922, the reader device 904 may perform a lookup for the K-MACi from the corresponding K-MACi-IND received at 921. In other words, the reader device 904 may use the K-MACi-IND that was received at 921 to determine the K-MACi value.

At 923, after processing the third message (i.e. the MSG3), the reader device 904 may transmit a fourth message (i.e. a MSG4) to the AIOT device 902. The fourth message (i.e. the MSG4) may include MAC data which is for contention resolution. The contention resolution message may include the AIOT device 902 identity and a C-RNTI that is assigned to the AIOT device 902.

The reader device 904 processing the third message (i.e. the MSG3) includes determining the K-MACi value that corresponds to the K-MACi-IND value that was received from the AIOT device 902. If the reader device 904 determines that the K-MACi-IND value is correct, then the reader device 904 may determine to transmit the fourth message (i.e. the MSG4). Determining that the K-MACi-IND value is correct means that the K-MACi-IND value may be used to determine a valid K-MACi value. The fourth message (i.e. the MSG4) may indicate to the AIOT device 902 that the received K-MACi-IND value is correct. The presence of the C-RNTI in the fourth message (i.e. the MSG4) may be an indication to the AIOT device 902 that the reader device 904 has determined that the K-MACi-IND value is correct.

If the reader device 904 determines that the K-MACi-IND value is not correct, then the reader device 904 may still determine to send the fourth message (i.e. the MSG4). The fourth message (i.e. the MSG4) may indicate to the AIOT device 902 that the received K-MACi-IND value is not correct. The reader device 904 may include no C-RNTI in the fourth message (i.e. the MSG4) and a fact that the fourth message (i.e. the MSG4) includes no C-RNTI may be an indication to the AIOT device 902 that the reader device 904 has determined that the K-MACi-IND value is not correct. Alternatively, if the reader device 904 determines that the K-MACi-IND value is not correct, then the reader device 904 may determine to not send the fourth message (i.e. the MSG4). Determining that the K-MACi-IND value is not correct may mean that the K-MACi-IND value cannot be used to determine the valid K-MACi value.

In case of failure, where in the AIOT device 902 was not able to determine a correct K-MACi-IND value, this may be determined by not receiving the fourth message (i.e. the MSG4) from the reader device 904, the AIOT device 902 may restart at 917 by randomly selecting and solving another puzzle.

At 924, the AIOT device 902 and the reader device 904 have established the ephemeral security context. The ephemeral security context is based on the K-MACi. After 924, the AIOT device 902 may use the ephemeral security context to encrypt the data that the AIOT device 902 transmits to the reader device 904 and the reader device 904 may use the ephemeral security context to encrypt data that the reader device 904 transmits to the AIOT device 902. Thus, information can be sent more securely between the AIOT device 902 and the reader device 904.

In an embodiment, the present disclosure provides a method for a modified AIOT random access procedure for establishing the ephemeral security between the AIOT device and the reader device.

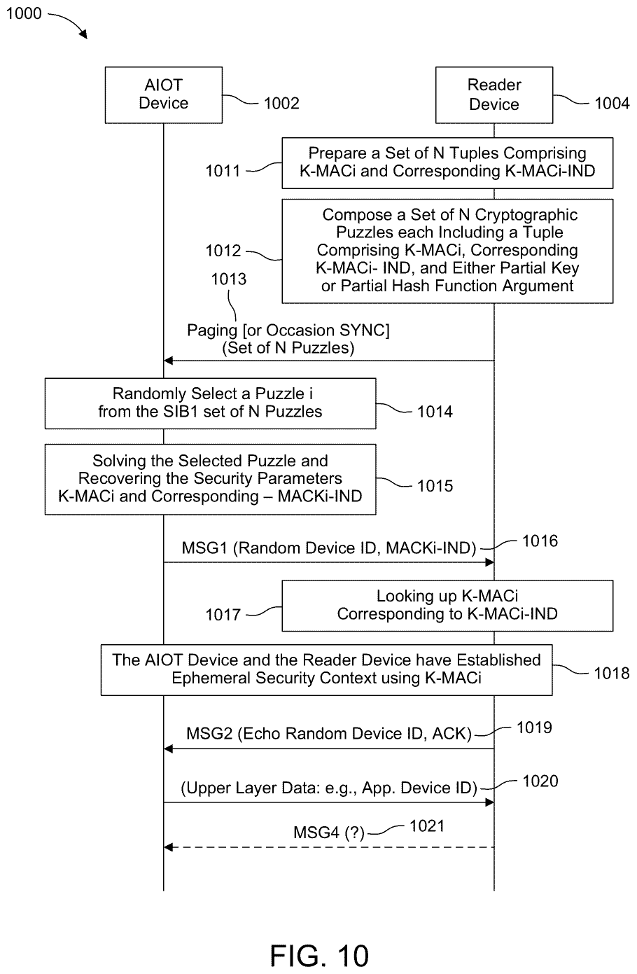

FIG. 10 illustrates an example process 1000 of a modified AIOT random access procedure for establishing the ephemeral security between an AIOT device 1002 and a reader device 1004 in an embodiment. The process 1000 illustrates an example of how the ephemeral security may be established between the AIOT device 1002 and the reader device 1004, and/or between the AIOT device 1002 and the network, during the random access procedure.

At 1011, the reader device 1004 determines to prepare the set of cryptographic puzzles. The reader device 1004 may prepare the set of N tuples. Each tuple including the key (i.e. the K-MACi) and the corresponding key index (i.e. the K-MACi-IND) corresponding to the key.

At 1012, the reader device 1004 composes the set of N cryptographic puzzles each hiding the tuple including the ephemeral key (i.e. the K-MACi), the corresponding ephemeral key index (i.e. the K-MACi-IND), and the partial key and/or the partial hash function argument.

At 1013, the reader device 1004 transmits a paging message and a set of occasion synchronization messages. A combination of the paging message and one or more synchronization messages may identify which of the one or more AIOT devices should respond to the paging message. In an example, the combination of the paging message and the one or more synchronization messages may identify which of the one or more AIOT devices should perform the random access procedure.

At 1014, the AIOT device 1002 uses the information in the paging message and the one or more synchronization messages to determine that the AIOT device 1002 needs to respond to the paging message. In other words, the AIOT device 1002 determines that the AIOT device 1002 needs to perform the RACH procedure. If the AIOT device 1002 determines that the AIOT device 1002 needs to perform the RACH procedure, then, the AIOT device 1002 may randomly select one puzzle from the set of N puzzles that were received in (and/or indicated by) the paging message and/or the puzzle message. If the AIOT device 1002 does not determine that the AIOT device 1002 needs to perform the RACH procedure, and/or the AIOT device 1002 determines that the strength of the puzzle, as determined by the puzzle number, does not satisfy certain one or more requirements, then the process 1000 may be stopped at 1014 and the AIOT device 1002 may not perform the RACH procedure. Determining that the strength of the puzzle does not satisfy one or more AIOT security requirements for an application may mean that the selected puzzle strength may compromise information used by the application after the security context is established with the puzzle of a certain strength.

At 1015, the AIOT device 1002 solves the selected puzzle and recovers the security parameters.

At 1016, the AIOT device 1002 selects an occasion (using at least slotted ALOHA as the baseline), and transmits a random device ID in the first message (i.e. the MSG1). The first message (i.e. the MSG1) also includes the recovered K-MACi-IND.

At 1017, the reader device 1004 performs a lookup for the K-MACi from the corresponding K-MACi-IND received at 1016.

At 1018, the AIOT device 1002 and the reader device 1004 enter a state where the AIOT device 1002 and the reader device 1004 have established the ephemeral security context using the K-MACi. The subsequent messages of the process 1000 may now be confidentiality and/or integrity protected using the ephemeral security context based on the K-MACi. In other words, the AIOT device 1002 and the reader device 1004 have established the ephemeral security context. The ephemeral security context is based on the K-MACi. After 1018, the AIOT device 1002 may use the ephemeral security context to encrypt the data that the AIOT device 1002 transmits to the reader device 1004 and the reader device 1004 may use the ephemeral security context to encrypt the data that the reader device 1004 transmits to the AIOT device 1002. Thus, information may be sent more securely between the AIOT device 1002 and the reader device 1004.

At 1019, upon successful reception of the first message (i.e. the MSG1), the reader device 1004 transmits the second message (i.e. the MSG2) by including the received random device ID in the second message (i.e. the MSG2). The reader device 1004 may use the K-MACi to encrypt some or all of the information in the second message (i.e. the MSG2).

At 1020, the AIOT device 1002 uses the K-MACi to decrypt some or all of the information in the second message (i.e. the MSG2). The random device ID is an example of information that is carried in the second message (i.e. the MSG2). If the AIOT device 1002 determines that the random device ID that the AIOT device 1002 transmitted at 1016 is included in the second message (i.e. the MSG2), then the AIOT device 1002 transmits the third message (i.e. the MSG3) which includes upper-layer data (e.g., an application layer device ID). The AIOT device 1002 may use the K-MACi to encrypt some or all of the information in the third message (i.e. the MSG3).

At 1021, the reader device 1004 uses the K-MACi to decrypt some or all of the information in the third message (i.e. the MSG3). The reader device 1004 may then transmit a fourth message (i.e. MSG4), e.g., for subsequent command transmission, but the contention may already be resolved at the second message (i.e. the MSG2) transmission. The reader device 1004 may use the K-MACi to encrypt some or all of the information in the fourth message (i.e. the MSG4).

In an embodiment, the present disclosure provides using the ephemeral security context obtained in the course of the RACH procedure to remediate against the SPARROW attack. In S3-213815 (GSMA FSAG incoming LS) stealth pirating attack by RACH rebroadcast overwriting (SPARROW) is described at SA3 #105 extensively in SA3, online and over offline calls. The SPARROW takes advantage of the WTRU (and/or the UE) transmitting a randomly generated contention resolution identity (CRI) during the contention resolution (CR) phase of the random access (RA) procedure. The NB acknowledges the receipt of the CRI by broadcasting a received CRI value, thereby establishing a covert communication channel.

The SPARROW attack exploits the contention-based RACH procedure (as described in 36.321 and 38.321). Specifically, a case for multiple WTRUs that have chosen the same preamble and may also simultaneously react upon a single downlink RACH response, sending simultaneously RRC connection requests with their 40-bit WTRU-identities included (random value and/or S-TMSI), only one of which may eventually be accepted by the network, which may be signaled back by echoing the accepted 40-bit WTRU identity.

If in uplink, a malicious WTRU_A injects (according to the scheme defined in 36.321 6.1.3.4 and 38.321 6.1.3.3) a value that is not random, but represents each time some encoding of a message that it wants to transmit, the node would echo it in downlink on the DL-SCH, WTRU_B could intercept that to receive the message without leaving any trace on the network. This would be a potential fraud and/or consume an operator's resources. In SA3 #105 a rough agreement over the attack itself was reached.

In an embodiment, the present disclosure provides the remediation of the SPARROW attack using the MAC layer security association to encrypt the echoed message (e.g. the second message), making only the authorized WTRU and/or the AIOT device able to read the echoed message.

In an example, the SPARROW remediation solution is based on the modified agreed AIOT random access procedure for establishing the ephemeral security between the AIOT device and the reader device. However, it may be equally successful in remediating SPARROW-type attacks in other environments, e.g., for NR RACH procedure.

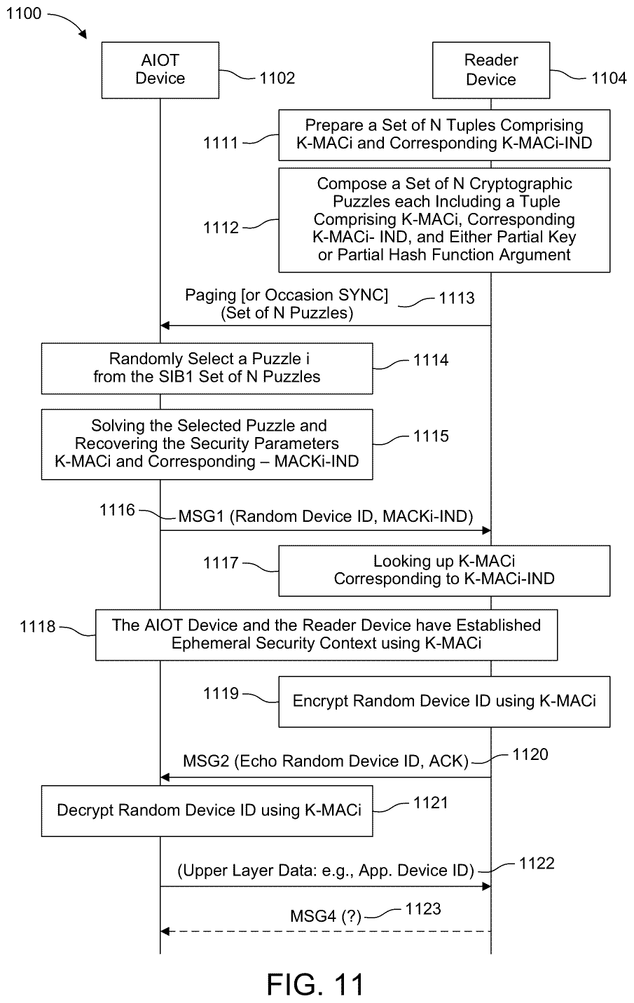

FIG. 11 illustrates a process 1100 for the modified random access procedure for remediation of the SPARROW attack in an embodiment. The process 1100 may be performed by an AIOT device 1102 and a reader device 1104.

At 1111, the reader device 1104 may prepare the set of N tuples including the K-MACi and corresponding K-MACi-IND.

At 1112, the reader device 1104 composes the set of N cryptographic puzzles each including a tuple including K-MACi, the corresponding K-MACi-IND, and the partial key and/or the partial hash function agreement.

At 1113, the reader device 1104 transmits the paging signal and/or the one or more synchronization occasions to the AIOT device 1102.

At 1114, the AIOT device 1102 randomly selects the puzzle i from the SIB1 set of N cryptographic puzzles.

At 1115, the AIOT device 1102 solves the selected puzzle and recovers the security parameters such as the K-MACi and the corresponding K-MACi-IND.

At 1116, the AIOT device 1102 transmits the first message (i.e. the MSG1) to the reader device 1104. The first message (i.e. the MSG1) may include the random device ID and/or the K-MACi-IND.

At 1117, the reader device 1104 may look up the K-MACi corresponding to the K-MACi-IND.

At 1118, the AIOT device 1102 and the reader device 1104 establish the ephemeral security context using the K-MACi.

At 1119, the reader device 1104 may use an appropriate agreed symmetrical encryption algorithm (e.g., AES-128) with the K-MACi key to encrypt the random device ID.

At 1120, upon successful reception of the first message (i.e. the MSG1), the reader device transmits the second message (i.e. the MSG2) by including the encrypted random device ID in the second message (i.e. the MSG2).

At 1121, the AIOT device 1102 uses an appropriate agreed symmetrical encryption algorithm (e.g., AES-128) with the K-MACi key to decrypt the random device ID. In an example, when the AIOT device 1102 receives the first message (i.e. the MSG1), the AIOT device 1102 may use the K-MACi key to decrypt the information in the first message (i.e. the MSG1). The information in the first message (i.e. the MSG1) may include the random device ID. In an example, the AIOT device 1102 determines whether the paging message includes an identifier associated with the AIOT device 1102. The AIOT device 1102 transmits the first message to the reader device 1104 on a condition that the paging message includes the identifier associated with the AIOT device 1102.

At 1122, the AIOT device 1102 transmits the upper layer data e.g. the application device ID to the reader device 1104.

At 1123, the reader device 1104 transmits the fourth message (i.e. the MSG4) to the AIOT device 1102.

In an embodiment, the present disclosure provides a method for the AIOT device identity and security bootstrapping.

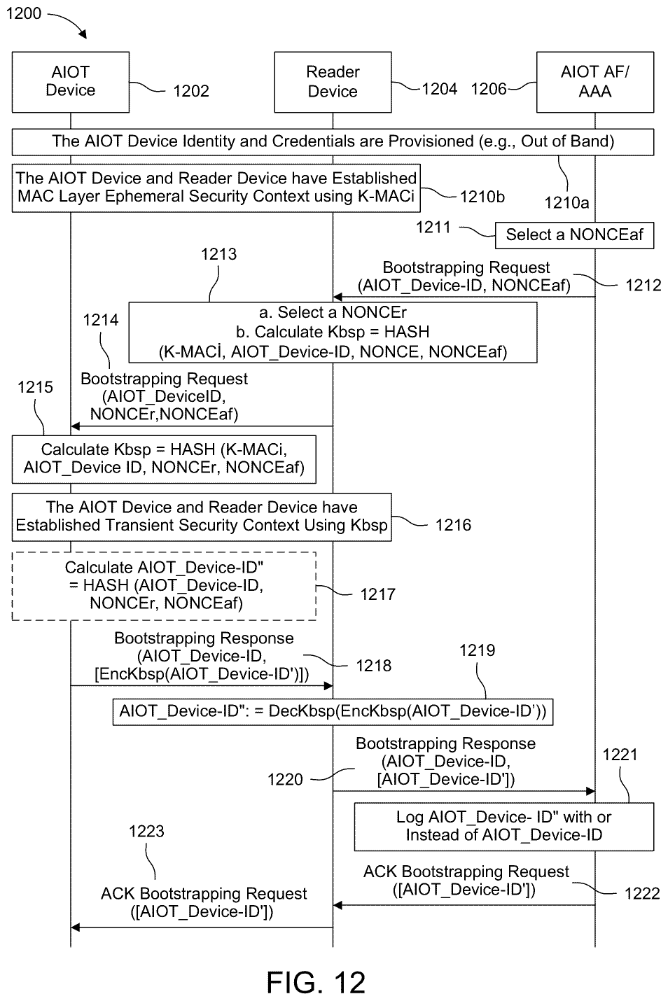

FIG. 12 illustrates an example process 1200 for the AIOT device identity and security bootstrapping in an embodiment. The process 1200 may be implemented by an AIOT device 1202, a reader device 1204, and an AIOT AF and/or a AAA 1206. At 1210a, the AIOT device identity and/or credentials are provisioned and/or pre-provisioned (e.g., at factory, post-production, and/or by the AIOT operator and/or AF etc.). At 1210b, the AIOT device 1202 and the reader device 1204 establish the MAC layer ephemeral security context using the K-MACi. In an example, the MAC layer ephemeral security context may be established.

At 1211, the AIOT AF and/or the AAA 1206 selects a specific NONCEaf.

At 1212, the AIOT AF and/or the AAA 1206 transmits a bootstrapping request that includes an AIOT_Device-ID and the NONCEaf to the reader device 1204.

At 1213, the reader device 1204 selects a NONCEr. The reader device 1204 calculates a bootstrapping key Kbsp=HASH (K-MACi, AIOT_Device-ID, NONCEr, NONCEaf).

At 1214, the reader device 1204 transmits a bootstrapping request that includes the AIOT_Device-ID, the NONCEr, and/or the NONCEaf to the AIOT device 1202.

At 1215, the AIOT device 1202 calculates the bootstrapping key Kbsp=HASH (K-MACI, AIOT_Device-ID, NONCEr, NONCEaf).

At 1216, the AIOT device 1202 and the reader device 1204 have established a transient security context (i.e., longer in duration and/or stay than “ephemeral”) using Kbsp.

At 1217, the AIOT device 1202 calculates a replacement identity AIOT_Device-ID′=HASH (AIOT_Device-ID, NONCEr, NONCEaf). This may be needed only when there is a need for a replacement identity AIOT_Device-ID′ for the AIOT device 1202.

At 1218, the AIOT device 1202 transmits a bootstrapping response containing the replacement identity AIOT_Device-ID′ encrypted using the Kbsp. The AIOT_Device-ID′ is optional and may be used when this procedure is used to agree on the replacement identity AIOT_Device-ID′ for the AIOT device 1202.

At 1219, the reader device 1204 decrypts the replacement identity AIOT_Device-ID′ using the Kbsp as in AIOT_Device-ID′=DecKbsp (EncKbsp (AIOT_Device-ID′)). This may be needed only when there is a need for a replacement identity AIOT_Device-ID′ for the AIOT device.

At 1220, the reader device 1204 transmits the bootstrapping response message with the AIOT_Device-ID and the optional AIOT_Device-ID′ to the AIOT AF and/or the AAA 1206. In an example, including the AIOT_Device-ID′ may be needed only when there is a need for a replacement identity AIOT_Device-ID′ for the AIOT device 1202.

At 1221, the AIOT AF and/or the AAA 1206 may log (i.e., map) the AIOT_Device-ID′ to the AIOT_Device-ID. This may be needed only when there is a need for the replacement identity AIOT_Device-ID′ for the AIOT device 1202.

At 1222, the AIOT AF and/or the AAA 1206 may transmit the ACK bootstrapping response message to the reader device 1204 including the optional AIOT_Device-ID′. In an example, including the AIOT_Device-ID′ may be needed only when there is a need for the replacement identity AIOT_Device-ID′ for the AIOT device 1202.

At 1223, the reader device 1204 transmits the ACK bootstrapping response message to the AIOT device 1202 including the optional AIOT_Device-ID′. In an example, including the AIOT_Device-ID′ is needed only when there is a need for the replacement identity AIOT_Device-ID′ for the AIOT device 1202.

In an embodiment, the present disclosure provides EAP authentication procedure protected by a security tunnel based on the MAC security context.

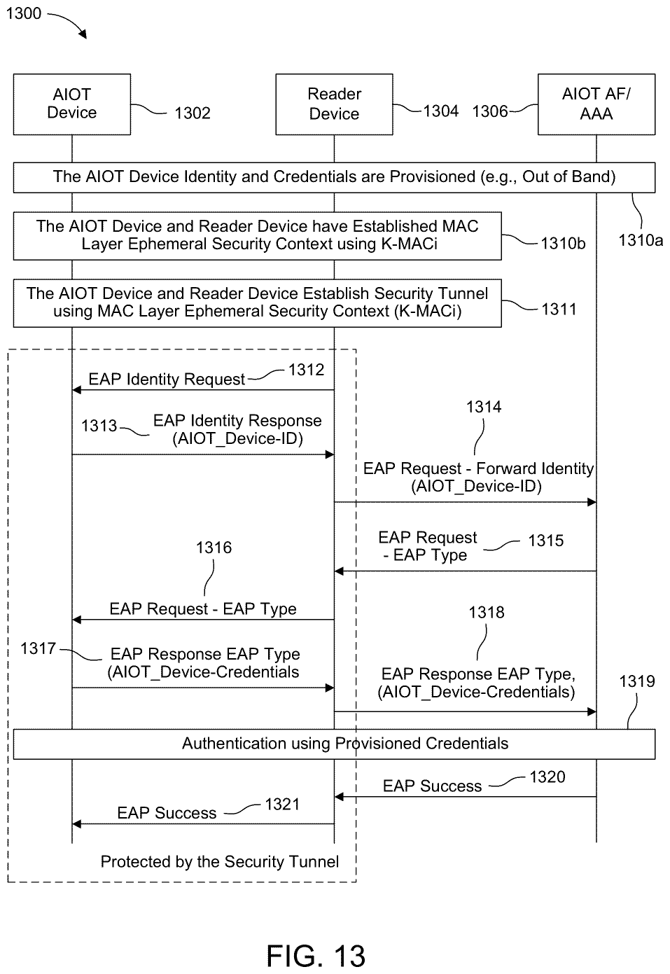

FIG. 13 illustrates an example process 1300 for the EAP authentication procedure protected by the security tunnel based on the MAC security context in an embodiment. The process 1300 may be performed by an AIOT device 1302, a reader device 1304, and an AIOT AF and/or the AAA 1306.

At 1310a, the AIOT device 1302 identity and/or credentials are provisioned and/or pre-provisioned (e.g., at the factory, the post-production, or by the AIOT AF and/or the AAA etc.).

At 1310b, the AIOT device 1302 and the reader device 1304 may establish the MAC layer ephemeral security context using the K-MACi. The MAC layer ephemeral security context may be established.

At 1311, the AIOT device 1302 and the reader device 1304 may establish the security tunnel with terminating points at the AIOT device and the reader device 1304 to establish confidentiality and/or integrity, protect over the air (OTA) message exchanges between the AIOT device 1302 and the reader device 1304.

At 1312, the reader device 1304 may transmit the EAP identity request message to the AIOT device 1302.

At 1313, the AIOT device 1302 may transmit the EAP identity response message including the AIOT_Device-ID to the reader device 1304.

At 1314, the reader device 1304 may transmit the EAP identity response message including the AIOT_Device-ID to the AIOT AF and/or the AAA 1306.

At 1315-1316, the AIOT AF and/or the AAA 1306 may transmit the EAP request-EAP message type to the reader device 1304 to be relayed to the AIOT device 1302.

At 1317, the AIOT device 1302 responds with the EAP response-EAP message type with included AIOT_Device-Credentials to the reader device 1304.

At 1318, the reader device 1304 may transmit the EAP response-EAP message type with included AIOT_Device-Credentials to the AIOT AF and/or the AAA 1306.

At 1319, the AIOT AF and/or the AAA 1306 (e.g. the EAP server), the reader device 1304 (e.g. the EAP authenticator), and the AIOT device 1302 (e.g. the EAP supplicant) participate in the authentication of the AIOT device 1302 with the AIOT_Device-ID and/or the AIOT_Device-Credentials.

At 1320-1321, upon successful authentication, the AIOT AF and/or the AAA 1206 may transmit an EAP success message to the reader device 1304 to be relayed to the AIOT device 1302. It may be utilized for authorization of the AIOT device 1302. In an example, one or more specific authorization credentials may be provisioned in 1310a and transmitted to the AIOT AF and/or the AAA 1306.

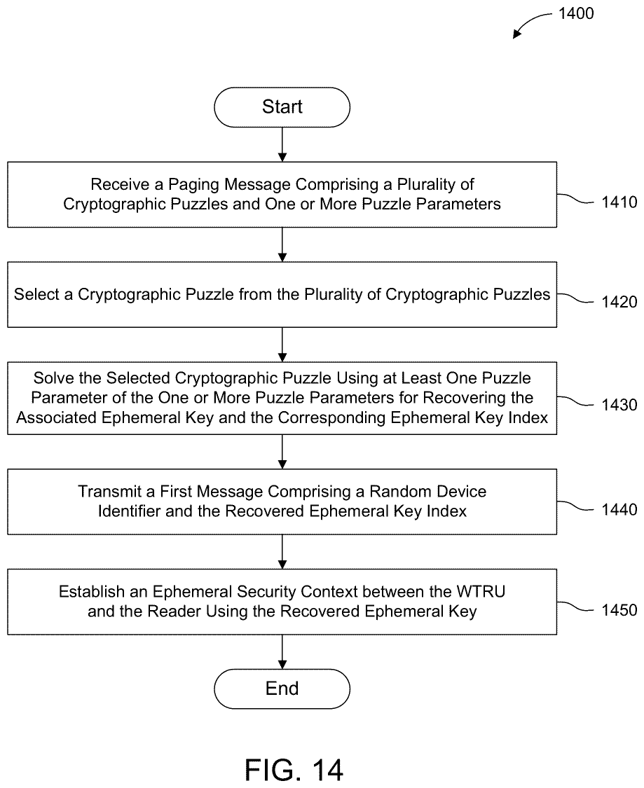

FIG. 14 is a flowchart illustrating an example process 1400 performed by the AIOT device in an embodiment. At 1410, the AIOT device receives the paging message and/or the puzzle message from the reader device. The paging message and/or the puzzle message is indicative of the plurality of cryptographic puzzles and one or more puzzle parameters. Each cryptographic puzzle of the plurality of cryptographic puzzles is associated with the corresponding ephemeral key. Each ephemeral key is associated with the corresponding ephemeral key index.

At 1420, the AIOT device selects one cryptographic puzzle from the plurality of cryptographic puzzles.

At 1430, the AIOT device solves the selected cryptographic puzzle using at least one puzzle parameter of the one or more puzzle parameters associated with the selected cryptographic puzzle. The AIOT device recovers the associated ephemeral key and the corresponding ephemeral key index by solving the selected cryptographic puzzle.

At 1440, the AIOT device transmits the first message to the reader device. The first message comprises the random device identifier and the recovered ephemeral key index.

At 1450, the AIOT device establishes the ephemeral security context between the AIOT device and the reader device using the recovered ephemeral key.

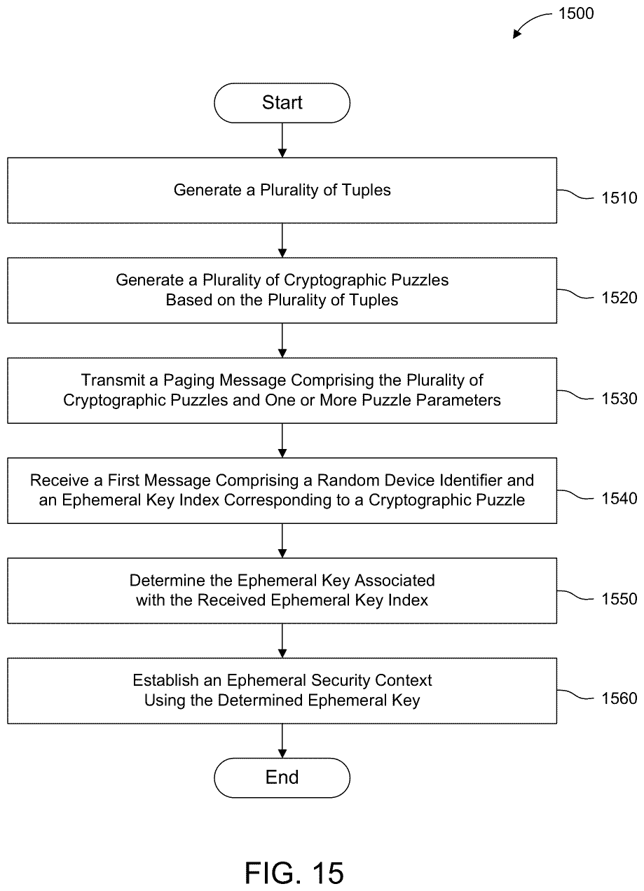

FIG. 15 is a flowchart illustrating an example process 1500 performed by the reader device in an embodiment. At 1510, the reader device generates a plurality of tuples. Each tuple of the plurality of tuples comprises corresponding ephemeral key and the corresponding ephemeral key index.

At 1520, the reader device generates a plurality of cryptographic puzzles based on the plurality of tuples. Each cryptographic puzzle of the plurality of cryptographic puzzles corresponds to a tuple of the plurality of tuples.

At 1530, the reader device transmits the paging message and/or the puzzle message to the one or more AIOT devices. The paging message and/or the puzzle message comprises the plurality of cryptographic puzzles and the one or more puzzle parameters.

At 1540, the reader device receives the first message from the AIOT device. The first message comprises the random device identifier and the ephemeral key index.

At 1550, the reader device determines the ephemeral key associated with the received ephemeral key index.

At 1560, the reader device establishes the ephemeral security context with the AIOT device using the determined ephemeral key.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving, from a reader device, a paging message;
receiving, from the reader device, a puzzle message indicative of a plurality of cryptographic puzzles and one or more puzzle parameters, wherein each cryptographic puzzle of the plurality of cryptographic puzzles is associated with an ephemeral key and a corresponding ephemeral key index;
selecting a cryptographic puzzle from the plurality of cryptographic puzzles;
solving the selected cryptographic puzzle using at least one puzzle parameter of the one or more puzzle parameters associated with the selected cryptographic puzzle for recovering the ephemeral key associated with the selected cryptographic puzzle and its corresponding ephemeral key index; and
transmitting, to the reader device, a first message comprising a random device identifier and the ephemeral key index.

2. The method of claim 1, wherein the WTRU is an ambient internet of things (AIOT) device.

3. The method of claim 1, the method further comprising:
establishing an ephemeral security context between the WTRU and the reader device using the ephemeral key.

4. The method of claim 1, the method further comprising:
receiving, from the reader device, a synchronization message indicative of a plurality of transmission occasions; and
selecting a transmission occasion from the plurality of transmission occasions using a slotted additive links on-line Hawaii area (ALOHA) protocol,
wherein the first message is transmitted using the selected transmission occasion.

5. The method of claim 1, wherein the plurality of cryptographic puzzles include at least one of: a cyphertext or a cryptographic hash function, and wherein the one or more puzzle parameters include at least one of: a partial encryption key or a partial input hash function argument.

6. The method of claim 5, wherein solving the selected cryptographic puzzle comprises brute-forcing at least one of: the cyphertext or the cryptographic hash function using at least one of: the partial encryption key or the partial input hash function argument respectively.

7. The method of claim 1, wherein selecting the cryptographic puzzle from the plurality of cryptographic puzzles comprises:
selecting the cryptographic puzzle from the plurality of cryptographic puzzles if a corresponding puzzle strength meets one or more security requirements.

8. The method of claim 1, wherein transmitting the first message to the reader device is for initiating a random access procedure.

9. The method of claim 1, the method further comprising:
receiving a second message from the reader device in response to the first message; and
on a condition that the second message comprises the random device identifier encrypted using the ephemeral key,
decrypting the second message using the ephemeral key.

10. The method of claim 1, wherein the first message is transmitted on a condition that the paging message includes an identifier associated with the WTRU.

11. A wireless transmit/receive unit (WTRU) comprising:
a memory;
a transceiver; and
a processor, wherein the transceiver and the processor are configured to:
receive, from a reader device, a puzzle message indicative of a plurality of cryptographic puzzles and one or more puzzle parameters, wherein each cryptographic puzzle of the plurality of cryptographic puzzles is associated with an ephemeral key and a corresponding ephemeral key index,
select a cryptographic puzzle from the plurality of cryptographic puzzles,
solve the selected cryptographic puzzle using at least one puzzle parameter of the one or more puzzle parameters associated with the selected cryptographic puzzle to recover the ephemeral key associated with the selected cryptographic puzzle and its corresponding ephemeral key index, and
transmit, to the reader device, a first message comprising a random device identifier and the ephemeral key index.

12. The WTRU of claim 11, wherein the WTRU is an AIOT device.

13. The WTRU of claim 11, wherein the transceiver and the processor are further configured to:
establish an ephemeral security context between the WTRU and the reader device using the ephemeral key.

14. The WTRU of claim 11, wherein the transceiver and the processor are further configured to:
receive, from the reader device, a synchronization message indicative of a plurality of transmission occasions, and
select a transmission occasion from the plurality of transmission occasions using a slotted additive links on-line Hawaii area (ALOHA) protocol,
wherein the first message is transmitted using the selected transmission occasion.

15. A method for communicating with an ambient internet of things (AIOT) device, the method comprising:
generating a plurality of tuples, wherein each tuple of the plurality of tuples comprises an ephemeral key and a corresponding ephemeral key index;
generating a plurality of cryptographic puzzles based on the plurality of tuples;
transmitting, to the AIOT device, a puzzle message indicative of the plurality of cryptographic puzzles and one or more puzzle parameters;
receiving, from the AIOT device, a first message comprising a random device identifier and an ephemeral key index corresponding to a cryptographic puzzle of the plurality of cryptographic puzzles;
determining the ephemeral key associated with the received ephemeral key index; and
establishing an ephemeral security context with the AIOT device using the determined ephemeral key.

16. The method of claim 15, wherein the plurality of cryptographic puzzles include at least one of: a cyphertext or a cryptographic hash function, and wherein the one or more puzzle parameters include at least one of: a partial encryption key or a partial input hash function argument.

17. The method of claim 16, the method further comprising:
modifying a puzzle strength associated with a cryptographic puzzle of the plurality of cryptographic puzzles based on one or more of:
a memory productivity of the AIOT device,
a processing productivity of the AIOT device,
an amount of time required to solve the cryptographic puzzle, or
an amount of effort required to solve the cryptographic puzzle.

18. The method of claim 17, wherein modifying the puzzle strength associated with the cryptographic puzzle comprises changing a proportion between at least one of:
the partial encryption key and a corresponding encryption key, or
the partial input hash function argument and a corresponding input hash function argument.

19. The method of claim 15, further comprising:
transmitting, to the AIOT device, a second message comprising the received random device identifier and an acknowledgement; and
encrypting the received random device identifier in the second message using the determined ephemeral key.

20. The method of claim 15, wherein the method is performed by at least one of:
an AIOT reader device,
a wireless transmit/receive unit,
a base station, or
a network function.
